(19) United States
(12) Patent Application Publication
(10) Pub. No.: US 2022/0180871 A1
(43) Pub. Date: Jun. 9, 2022

(54) INFORMATION PROCESSING DEVICE, INFORMATION PROCESSING METHOD, AND PROGRAM

(71) Applicant: SONY GROUP CORPORATION, TOKYO (JP)

(72) Inventor: YURI AMIMOTO, TOKYO (JP)

(21) Appl. No.: 17/593,004

(22) PCT Filed: Mar. 6, 2020
(86) PCT No.: PCT/JP2020/009678

§ 371 Date: Sep. 3, 2021

(30) Foreign Application Priority Data
Mar. 20, 2019 (JP) 2019-052649

(51) Int. Cl. G10L 15/22; G10L 13/02; G10L 15/07; G10L 15/183; G10L 25/66

(52) U.S. Cl. CPC G10L 15/22; G10L 13/02; G10L 2015/225; G10L 15/183; G10L 25/66; G10L 15/07

(57) ABSTRACT

The present invention relates to an information processing device, an information processing method, and a program capable of achieving smoother dialog. A topic selection unit selects a topic appropriate to a context of an ongoing dialog on a basis of user information updated in accordance with a dialog state of a user, and a determination unit determines whether or not it is a timing to utter the topic in accordance with a time since a last occurrence of turn-taking in a dialog performed between a plurality of the users. The present technology can be applied to, for example, a dialog system that performs a chat with a user or assists a dialog between users.

### TECHNICAL FIELD

The present invention relates to an information processing device, an information processing method, and a program, and more particularly, to an information processing device, an information processing method, and a program capable of achieving smoother dialog.

### BACKGROUND ART

Conventionally, various services using dialog systems have been provided, and such dialog systems are mainly of two types including task-oriented and interactive dialog systems. Furthermore, the interactive type dialog systems include a task of chat dialog, and various types of information accumulated by, for example, crawling websites are used to select a topic at the time of generating an utterance.

For example, Patent Literature 1 discloses a conversation processing device that generates a response sentence for conversation with a user using information regarding a topic of a conversation with the user and a recognition result of recognizing an utterance of the user.

Note that Non-Patent Document 1 describes a time length during which a user feels psychological comfort for speaker alternation (turn-taking) when a plurality of users is in a dialog.

### CITATION LIST

### Patent Document

### Patent Document 1: Japanese Patent Application Laid-Open No. 2001-188787

### Non-Patent Document

Non-Patent Document 1: Heldner, Mattias, and Jens Edlund. “Pauses, gaps and overlaps in conversations.” Journal of Phonetics 38.4 (2010):555-568

### SUMMARY OF THE INVENTION

### Problems to be Solved by the Invention

By the way, in the conventional dialog system, the timing at which the dialog system autonomously utters may not be appropriate to a user who is in a dialog. Therefore, in addition to a difficulty of smoothly performing a dialog between the dialog system and the user, there is a technical difficulty in participation of the dialog system in a dialog between a plurality of users.

The present disclosure has been made in view of such a situation, and an object of the present disclosure is to enable a dialog with a user at a proper timing and to realize a smoother dialog by assisting a dialog between users on the spot.

### Solutions to Problems

An information processing device according to one aspect of the present disclosure includes: a topic selection unit that selects a topic appropriate to a context of an ongoing dialog on a basis of user information updated in accordance with a dialog state of a user; and a determination unit that determines whether or not it is a timing to utter the topic in accordance with a time since a last occurrence of turn-taking in a dialog performed between a plurality of the users.

An information processing method or a program according to one aspect of the present disclosure includes: selecting a topic appropriate to a context of an ongoing dialog on a basis of user information updated in accordance with a dialog state of a user; and determining whether or not it is a timing to utter the topic in accordance with a time since a last occurrence of turn-taking in a dialog performed between a plurality of the users.

In one aspect of the present disclosure, a topic appropriate to a context of an ongoing dialog is selected on a basis of user information updated in accordance with a dialog state of a user, and whether or not it is a timing to utter the topic is determined in accordance with a time since a last occurrence of turn-taking in a dialog performed between a plurality of the users.

### BRIEF DESCRIPTION OF DRAWINGS

FIG. 1 is a block diagram illustrating a configuration example of an embodiment of a dialog system including an information processing device to which the present technology is applied.

FIG. 2 is a block diagram illustrating a configuration example of a chat mode switching unit.

FIG. 3 is a block diagram illustrating a configuration example of a dialog state measurement unit.

FIG. 4 is a block diagram illustrating a configuration example of a topic selection unit.

FIG. 5 is a diagram for describing a voiceless section.

FIG. 6 is a flowchart for describing an information processing method.

FIG. 7 is a block diagram illustrating a configuration example of an embodiment of a computer to which the present technology is applied.

### MODE FOR CARRYING OUT THE INVENTION

Hereinafter, a specific embodiment to which the present technology is applied will be described in detail with reference to the drawings.

### Configuration Example of Dialog System

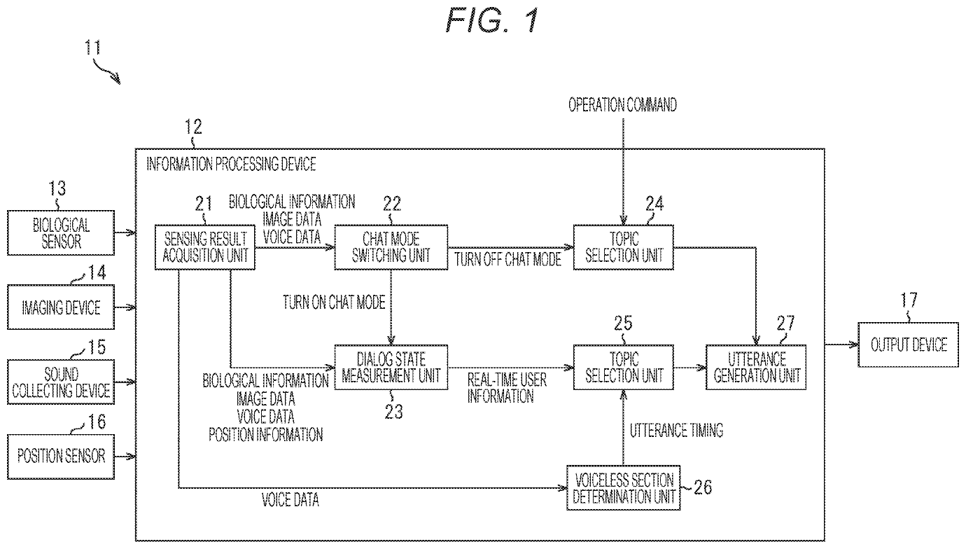

FIG. 1 is a block diagram illustrating a configuration example of an embodiment of a dialog system including an information processing device to which the present technology is applied.

In FIG. 1, a dialog system 11 includes an information processing device 12, a biological sensor 13, an imaging device 14, a sound collecting device 15, a position sensor 16, and an output device 17. Furthermore, the information processing device 12 includes a sensing result acquisition unit 21, a chat mode switching unit 22, a dialog state measurement unit 23, topic selection units 24 and 25, a voiceless section determination unit 26, and an utterance generation unit 27.

The information processing device 12 performs information processing necessary for providing a dialog with a user by the dialog system 11 in order to output, to the output device 17, an utterance generated on the basis of sensing results by the biological sensor 13, the imaging device 14, the sound collecting device 15, and the position sensor 16. For example, the information processing device 12 can start information processing when recognizing that a plurality of users is in a dialog at positions where sensing is possible, and perform information processing each time of turn-taking that is changing of speakers between the plurality of users.

The biological sensor 13 has, for example, a measurement function of measuring various characteristics that change with the biological activities of the users who are in a dialog, and measures, for example, the heart rates, the body temperatures, the exercise intensities, the pupil openings, and the like of the users who are in a dialog. Then, the biological sensor 13 supplies biological information indicating the measurement results to the information processing device 12.

The imaging device 14 includes, for example, an imaging element such as a complementary metal oxide semiconductor (CMOS) image sensor, acquires an image obtained by imaging a surrounding situation of the users who are in a dialog including the users, and supplies the image data to the information processing device 12.

The sound collecting device 15 includes, for example, a microphone and the like, collects voice uttered by the users who are in a dialog, and supplies the voice data to the information processing device 12.

The position sensor 16 includes, for example, an infrared sensor, a time of flight (ToF) sensor, or the like, detects the positions of the users in a range measurable by the position sensor 16, and supplies position information indicating the positions of the users to the information processing device 12.

The output device 17 includes, for example, a speaker and the like, and outputs voice in accordance with the voice data output from the information processing device 12.

The sensing result acquisition unit 21 acquires, as sensing results, biological information supplied from the biological sensor 13, image data supplied from the imaging device 14, voice data supplied from the sound collecting device 15, and position information supplied from the position sensor 16. Then, the sensing result acquisition unit 21 supplies the biological information, the image data, and the voice data to the chat mode switching unit 22, supplies the biological information, the image data, the voice data, and the position information to the dialog state measurement unit 23, and supplies the voice data to the voiceless section determination unit 26.

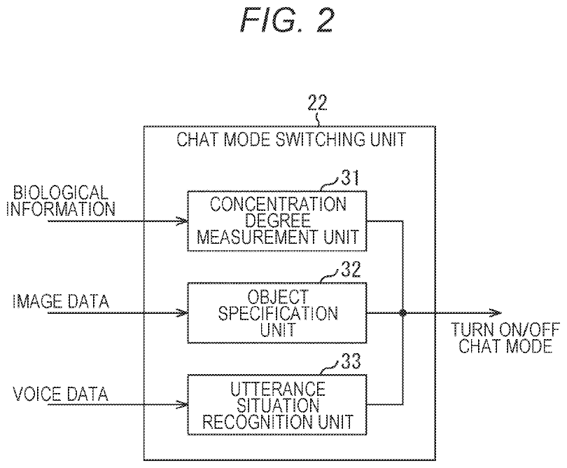

The chat mode switching unit 22 determines, on the basis of at least one of the biological information, the image data, or the voice data, whether or not the context expects the dialog system 11 to autonomously generate a chat, and switches on/off of the chat mode. For example, when the chat mode switching unit 22 determines that the dialog mode is a context expecting the dialog system 11 to autonomously generate a chat, the chat mode switching unit 22 determines to switch the mode to the chat mode, and notifies the dialog state measurement unit 23 that the dialog mode is on. On the other hand, when the chat mode switching unit 22 determines that the context does not expect the dialog system 11 to autonomously generate a chat, the chat mode switching unit 22 determines not to switch the mode to the chat mode, and notifies the topic selection unit 24 of that the chat mode is off. Note that a detailed configuration of the chat mode switching unit 22 will be described later with reference to FIG. 2.

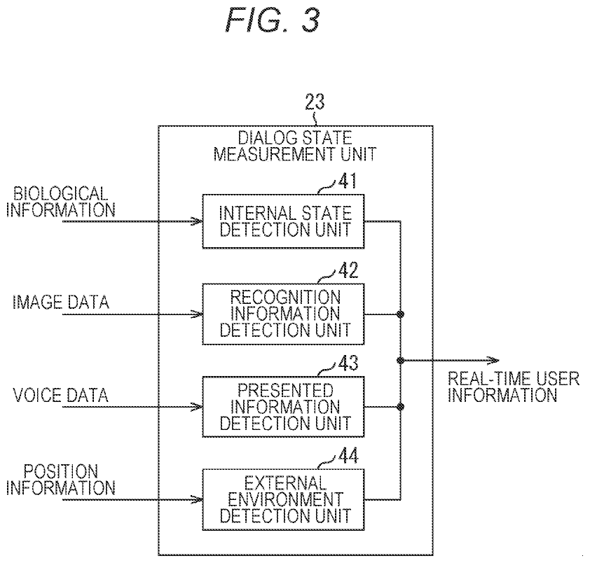

Upon receiving notification that the chat mode is on from the chat mode switching unit 22, the dialog state measurement unit 23 measures the dialog states of the users who are in a dialog on the basis of at least one of the biological information, the image data, the voice data, or the position information. Then, the dialog state measurement unit 23 acquires real-time user information regarding the user in accordance with the dialog state of the user acquired as a result of the measurement, and supplies the real-time user information to a topic selection unit 25. Note that a detailed configuration of the dialog state measurement unit 23 will be described later with reference to FIG. 3.

Upon receiving the notification that the chat mode is off from the chat mode switching unit 22, the topic selection unit 24 selects a topic based on, for example, user information registered in advance by the user in accordance with an operation command input by the user via an input unit (not illustrated). Then, the topic selection unit 24 supplies topic information indicating the selected topic to the utterance generation unit 27.

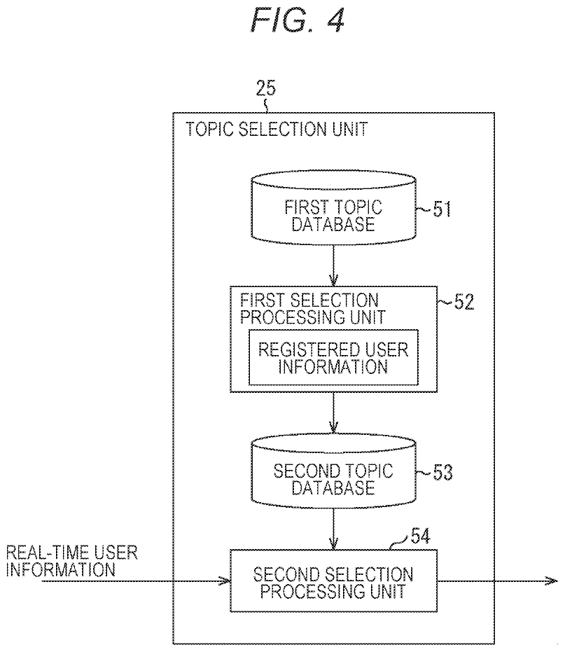

The topic selection unit 25 selects a topic appropriate to the content of the ongoing dialog and appropriate to the context of the situation on the basis of the real-time user information supplied from the dialog state measurement unit 23. Then, the topic selection unit 25 supplies topic information indicating the selected topic to the utterance generation unit 27 in accordance with the utterance timing based on the result of measurement of the voiceless section by the voiceless section determination unit 26. Note that a detailed configuration of the topic selection unit 25 will be described later with reference to FIG. 4.

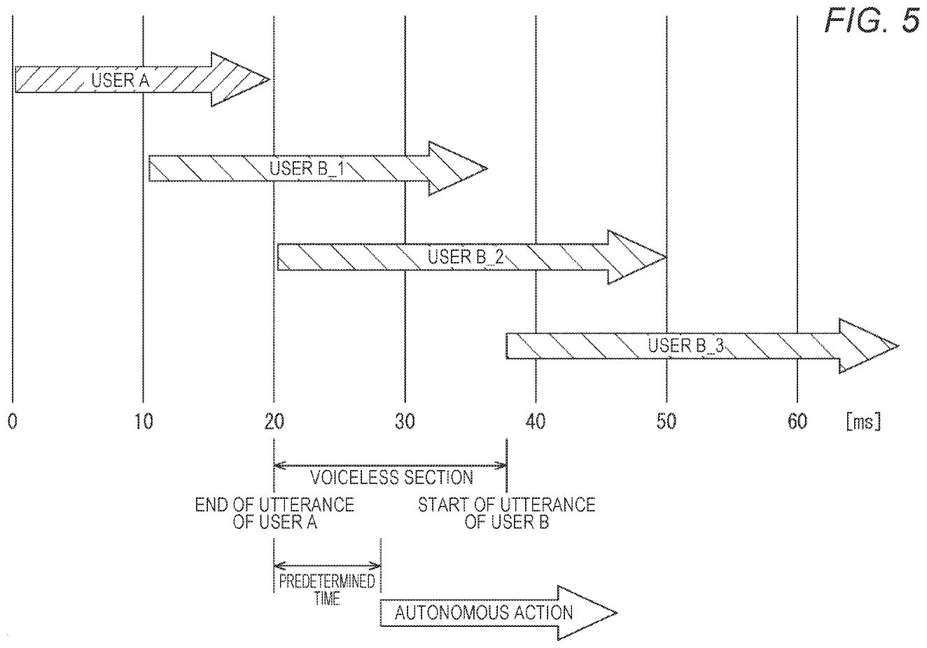

The voiceless section determination unit 26 measures a voiceless section on the basis of the voice data, and determines, on the basis of the measurement result, whether or not it is an utterance timing at which an autonomous action of the dialog system 11 is desirable for the users who are in a dialog. Then, in a case where the voiceless section determination unit 26 determines that it is an utterance timing, the voiceless section determination unit 26 notifies the topic selection unit 25 of the fact. Note that the voiceless section that causes determination of an utterance timing will be described later with reference to FIG. 5.

The utterance generation unit 27 generates voice data for performing an utterance in accordance with the topic indicated by the topic information supplied from the topic selection unit 24 or 25, and supplies the voice data to the output device 17. For example, the utterance generation unit 27 can generate voice data by incorporating a sound source recorded for each topic in advance, or can generate voice data by performing voice synthesis in real time from a text indicating the content of the topic.

FIG. 2 is a block diagram illustrating a configuration example of the chat mode switching unit 22.

As illustrated in FIG. 2, the chat mode switching unit 22 includes a concentration degree measurement unit 31, an object specification unit 32, and an utterance situation recognition unit 33.

On the basis of the biological information (heart rate, body temperature, pupil opening, and the like) acquired by the biological sensor 13, the concentration degree measurement unit 31 acquires, for example, the influence of a specific object on a user who is in a dialog, and measures the concentration degree of the user on the object.

The object specification unit 32 specifies, for example, an object in which the user who is in a dialog is interested on the basis of an image acquired by the imaging device 14.

The utterance situation recognition unit 33 recognizes, for example, an utterance situation when the user who is in a dialog makes an utterance, on the basis of the voice collected by the sound collecting device 15.

Then, the chat mode switching unit 22 determines whether or not the user who is in a dialog is in a state of allowing a chat on the basis of at least one of the concentration degree, measured by the concentration degree measurement unit 31, of the user on the object specified by the object specification unit 32 or the utterance situation of the user recognized by the utterance situation recognition unit 33. Then, in a case where the chat mode switching unit 22 determines that the user having the dialog is in a state of allowing a chat, the chat mode switching unit 22 turns on the chat mode. For example, the chat mode switching unit 22 determines that the user is not in a state of allowing a chat when the user is in an utterance situation in which the user concentrates on a specific object, matter, or the like or frequently makes an utterance, and turns off the chat mode in that case. Furthermore, for example, the chat mode switching unit 22 turns on the chat mode when it is difficult for the user to communicate (for example, when it can be estimated that the user is in a stress state in which the heart rate increases) although the user has to have a conversation in terms of context on the basis of a result of analyzing a context of a scene from voice, an image, or the like.

FIG. 3 is a block diagram illustrating a configuration example of the dialog state measurement unit 23.

As illustrated in FIG. 3, the dialog state measurement unit 23 includes an internal state detection unit 41, a recognition information detection unit 42, a presented information detection unit 43, and an external environment detection unit 44.

The internal state detection unit 41 detects the internal state of a user such as stress felt by the user in a dialog, a level of relaxation, a ratio of attention paid to the dialog, and the like on the basis of the biological information (heart rate, body temperature, pupil opening, and the like) acquired by the biological sensor 13.

On the basis of the image acquired by the imaging device 14, the recognition information detection unit 42 extracts, for example, the number of users, a body language performed at the time of a dialog between the users, an object represented by a demonstrative word, and the like. Therefore, the recognition information detection unit 42 detects the state of the environment recognized by the user, and acquires recognition information indicating the recognized state of the environment.

On the basis of the voice collected by the sound collecting device 15, the presented information detection unit 43 acquires, for example, rhythm information indicating tone (strength, rhythm, or the like) of the utterance in addition to character information that can be recognized by voice recognition. Then, the dialog state measurement unit 23 detects what is presented by the user, such as whether or not the user is interested in the conversation, the user's hometown (dialect), a conversation topic (language), or the like, and acquires presented information indicating what is presented, on the basis of the voice.

The external environment detection unit 44 detects, for example, an external environment (for example, the user's home, work place, other specific place, or the like) indicating a place where the user is in a dialog on the basis of the position information detected by the position sensor 16. Here, the external environment detection unit 44 may grasp details such as a cafe, a museum, or a hospital as specific places detected as the external environment, referring to map information or the like registered in advance.

Then, the dialog state measurement unit 23 supplies these detection results (at least one of an internal state, recognition information, presented information, or an external environment) to the topic selection unit 25 as real-time user information in accordance with the dialog state.

FIG. 4 is a block diagram illustrating a configuration example of the topic selection unit 25.

As illustrated in FIG. 4, the topic selection unit 25 includes a first topic database 51, a first selection processing unit 52, a second topic database 53, and a second selection processing unit 54.

In the first topic database 51, topics of a chat are registered in a form organized in categories. For example, in the first topic database 51, topics selected in the past are accumulated as metadata of topics with scores given by integrating the context when the respective topics are selected, the reaction of a user, and the like. In accumulating the metadata of topics in this manner, scores are given such that a low score is given to the content determined to be a topic that has a significantly low score and not preferred by a user and to the content that is highly similar to the content, so that those topics are unlikely to be selected. Moreover, in the first topic database 51, the registered topics can be automatically expanded by periodically performing crawl websites or the like, and at this time, the topics are registered so as not to duplicate the already registered topics.

The first selection processing unit 52 performs selection processing of selecting a topic based on user information registered in advance by the user with reference to the first topic database 51 and registering the selected topic in the second topic database 53. For example, as the user information registered in the first selection processing unit 52, it is assumed that a use history accumulated when the user uses the terminal on which the dialog system 11 is mounted, the age of the user, the gender of the user, and the like are used. Note that the topic selection unit 24 can also select a topic on the basis of user information registered in advance by the user with reference to the first topic database 51.

The topic selected by the first selection processing unit 52 is registered in the second topic database 53.

The second selection processing unit 54 performs selection processing of selecting a topic on the basis of real-time user information supplied from the dialog state measurement unit 23 with reference to the second topic database 53 and supplying the topic to the utterance generation unit 27. For example, the second selection processing unit 54 can analyze (classify) the matter of interest to the user and the polarity with respect to the object of interest by analyzing the meaning of the utterance content from the real-time user information, and select a topic appropriate to the context. Furthermore, the second selection processing unit 54 can extract a proper noun from the user's utterance, determine whether the verb appearing at that time is negative or positive, and select a topic appropriate to the context using the determination result.

Therefore, the topic selection unit 25 can efficiently select a topic that is most likely to be of interest to the user in the situation and that can elongate a dialog by using the registered user information and the real-time user information.

The voiceless section used by the voiceless section determination unit 26 to determine whether or not it is the utterance timing will be described with reference to FIG. 5.

For example, the voiceless section determination unit 26 uses, as a trigger of utterance timing, a voiceless section that occurs at the time of speaker change (turn-taking) when a plurality of users is in a dialog.

In general, it is considered that there is a time length in which the users feel psychological comfort for turn-taking, and the time length is described in detail in Non-Patent Document 1 described above. For example, it is said that, when there is a long silence during a dialog, the speaker feels that other speakers have some negative problem (the response is highly difficult, either side of the speakers does not have an intention to continue the conversation, or the like) with respect to the last utterance.

Therefore, in the dialog system 11, the voiceless section determination unit 26 can determine that it is the utterance timing when detecting a voiceless section exceeding the time length in which the users feel comfortable so that an excessively long voiceless section does not occur at the time of such turn-taking. Therefore, the dialog system 11 autonomously makes an utterance, thereby avoiding the occurrence of a voiceless section that greatly exceeds the time length in which the users feel comfortable at the time of turning-taking, and enabling the users to have a conversation smoothly.

For example, FIG. 5 illustrates three patterns of the timing of the utterance of a user B with respect to the utterance of a user A. At the timing of the utterance of the user B of the first pattern, the utterance or the user B overlaps with the utterance of the user A, and thus a voiceless section does not occur (there is a minus voiceless section corresponding to the overlap). Furthermore, at the timing of the utterance of the user B of the second pattern, the conversation between the users is smoothly continued with almost no voiceless section. On the other hand, at the timing of the utterance of the user B of the third pattern, a long voiceless section occurs, and the comfort is lost in the conversation between the users.

Therefore, when the voiceless section determination unit 26 detects that the voiceless section from the end of the utterance of the user A to the start of the utterance of the user B exceeds a predetermined time set in advance as a time length in which the users feel comfortable (a time length in which the users feel comfortable at the time of turn-taking), like a case where the timing of the utterance of the user B is of the third pattern, the dialog system 11 takes an autonomous action.

Therefore, the voiceless section determination unit 26 can detect an utterance timing appropriate for the dialog system 11 to make an autonomous utterance.

### Processing Example of Information Processing

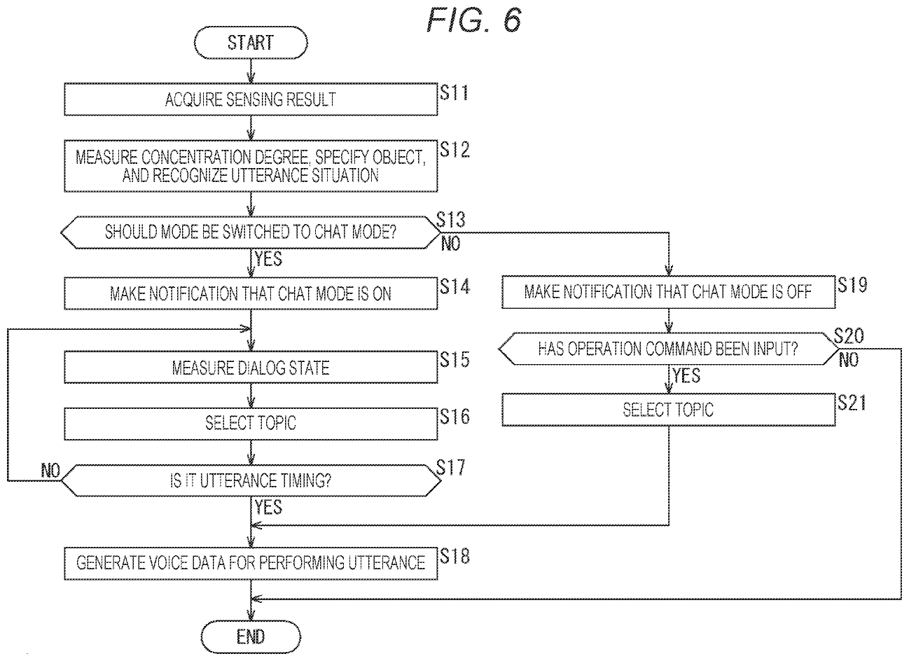

Information processing performed in the information processing device 12 in FIG. 1 will be described with reference to a flowchart illustrated in FIG. 6.

As described above, information processing is performed each time of turn-taking, and in step S11, the sensing result acquisition unit 21 acquires a sensing result. That is, the sensing result acquisition unit 21 acquires, as sensing results, biological information supplied from the biological sensor 13, image data supplied from the imaging device 14, voice data supplied from the sound collecting device 15, and position information supplied from the position sensor 16.

In step S12, in the chat mode switching unit 22, the concentration degree measurement unit 31 measures the concentration degree of a user, the object specification unit 32 specifies the object in which the user is interested, and the utterance situation recognition unit 33 recognizes the utterance situation of the user.

In step S13, the chat mode switching unit 22 determines whether or not to switch to the chat mode. For example, the chat mode switching unit 22 determines to switch to the chat mode in a case where the user in a dialog is in a state of allowing a chat on the basis of the degree of concentration of the user on the object specified in step S12, an utterance situation, or the like.

In step S13, in a case where the chat mode switching unit 22 determines to switch to the chat mode, the processing proceeds to step S14, and the dialog state measurement unit 23 is notified that the chat mode is on.

In step S15, the dialog state measurement unit 23 acquires real-time user information by measuring the dialog state of the user who is in a dialog on the basis of the sensing result acquired by the sensing result acquisition unit 21 in step S11, and supplies the real-time user information to the topic selection unit 25.

In step S16, the topic selection unit 25 selects a topic appropriate to the context of the situation as described above with reference to FIG. 4 on the basis of the real-time user information supplied from the dialog state measurement unit 23 in step S15.

In step S17, as described above with reference to FIG. 5, the voiceless section determination unit 26 determines whether or not it is the utterance timing by detecting the voiceless section exceeding the time length in which the user feels comfortable.

In step S17, in a case where the voiceless section determination unit 26 determines that it is not the utterance timing, the processing returns to step S15, and thereafter, processing similar to the above-described processing is repeated. On the other hand, in step S17, in a case where the voiceless section determination unit 26 determines that it is the utterance timing, the processing proceeds to step S18.

In step S18, the topic selection unit 25 supplies topic information indicating the topic selected in step S16 to the utterance generation unit 27. Then, the utterance generation unit 27 generates voice data for performing an utterance in accordance with the topic indicated by the topic information supplied from the topic selection unit 25, and supplies the voice data to the output device 17, and then the processing ends.

On the other hand, in a case where the chat mode switching unit 22 determines not to switch to the chat mode in step S13, the processing proceeds to step S19, and the topic selection unit 24 is notified that the chat mode is off.

In step S20, the topic selection unit 24 determines whether or not an operation command has been input by a user via an input unit (not illustrated).

In step S20, in a case where the topic selection unit 24 determines that an operation command has been input, the processing proceeds to step S21, and in a case where the topic selection unit 24 determines that an operation command has not been input, the processing ends.

In step S21, for example, the topic selection unit 24 selects a topic based on user information registered in advance by the user, and supplies topic information indicating the selected topic to the utterance generation unit 27. Thereafter, the processing proceeds to step S18, and the utterance generation unit 27 generates voice data for performing an utterance in accordance with the topic indicated by the topic information supplied from the topic selection unit 24, and supplies the voice data to the output device 17, and then the processing ends.

By performing the information processing as described above, the dialog system 11 can output, from the output device 17, voice in accordance with voice data for utterance regarding the topic selected by the topic selection unit 25. Therefore, the dialog system 11 can provide a topic customized for users in accordance with the context of the situation and perform a chat conversation more specialized for the users.

Furthermore, the dialog system 11 can generate an utterance at a more appropriate timing in accordance with the utterance situation in the situation by generating an utterance at an utterance timing in accordance with the detection of the voiceless section by the voiceless section determination unit 26. That is, the dialog system 11 extracts sensing results of a plurality of users, selects a topic of dialog, and makes an utterance in accordance with the utterance timing based on the turn-taking timing, so that it is possible to participate in a dialog so as to assist the dialog between the users on the spot, and to smoothly have a chat conversation without giving users a sense of incongruity.

Moreover, the dialog system 11 can perform word-level correlation and polarity classification in real time to select a topic.

Furthermore, even for an utterance from the user that prompts a dialog including a request for a dialog having no operation object such as “tell me something interesting” or “tell me something”, the dialog system 11 can start a dialog in a natural manner by acquiring the utterance as real-time user information and selecting a topic on the basis of the acquired user information (utterance content). Therefore, the user can enjoy a dialog with the dialog system 11 in a form that fits the user himself/herself without requesting the dialog system 11 for a dialog on his/her own.

Moreover, the dialog system 11 can be used in a use case where a dialog is made by acquiring a question from the user as real-time user information and selecting a more appropriate response as a topic.

For example, specifically, a case where a user spends time in a closed space including the inside of a vehicle with a partner who the user has met for the first time, such as when going to see the inside of a real estate is assumed as a situation where a psychological burden is large, and the case is assumed as a first use case where the dialog system 11 is used. Therefore, it is possible to reduce the psychological burden on the user.

Furthermore, a situation in which deepening of knowledge with respect to a topic of interest to a user himself/herself over a wide range through a chat is prompted is assumed as a second use case where the dialog system 11 is used. For example, when the dialog system 11 holds a topic corresponding to content that can make a user enjoy by having miscellaneous knowledge thereof such as art museums and other museums, the user can more effectively deepen the knowledge of the content. For example, in a case where a plurality of users is quietly looking at a predetermined painting of a certain artist in a museum, the dialog system 11 can identify the painting that the users are paying attention and make a dialog on the basis of knowledge about the painting (the hometown of the artist, the background on which the painting is drawn, or the like).

Furthermore, an event of a type in which a plurality of users has various experiences through the same route, such as a factory tour is assumed as a third use case where the dialog system 11 is used. For example, the dialog system 11 can throw a topic on a topic in which a plurality of users is interested for every group. Then, by using the dialog system 11, it can be expected that the users will autonomously commit to the experience as compared with tours of a style in which the number of guests is large such as a factory tour, or an attendant continues to talk.

Furthermore, a case where the dialog system 11 is used in a scene of living with an unfamiliar person when a disaster or the like occurs is assumed as a fourth use case. For example, the dialog system 11 can search for a common matter using user information regarding each user and generate a chat on the basis of the common matter. Therefore, the dialog system 11 can provide a topic that enables the users to easily talk to each other without searching for information about others.

Moreover, as another use case, it is assumed that the dialog system 11 is incorporated in, for example, a robot that substitutes for a conversation in marriage hunting. That is, by interposing such a robot therebetween, it is expected that persons can have a conversation smoothly and have a good communication even when they meet for the first time. In this manner, the dialog system 11 assists a dialog between users, and autonomously generates an utterance regarding a topic specialized for the users on the spot, thereby making the situation enable a smoother dialog.

### Configuration Example of Computer

Next, the above-described series of processing (information processing method) can be performed by hardware or software. In a case where the series of processing is performed by software, a program constituting the software is installed in a general-purpose computer or the like.

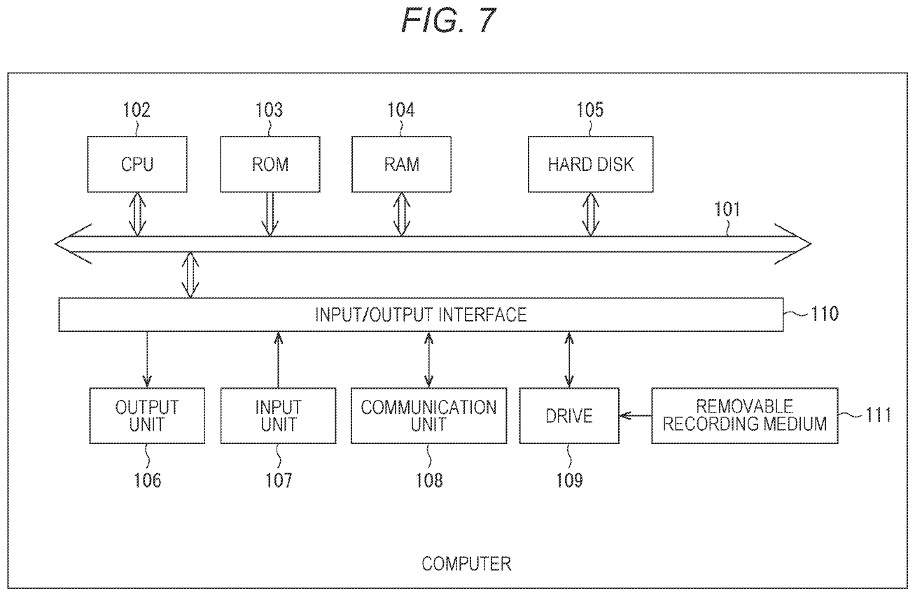

FIG. 7 is a block diagram illustrating a configuration example of an embodiment of a computer in which a program for performing the above-described series of processing is installed.

The program can be recorded in advance in a hard disk 105 or a ROM 103 as a recording medium included in the computer.

Alternatively, the program can be stored (recorded) in a removable recording medium 111 driven by a drive 109. The removable recording medium 111 described above can be provided as so-called package software. Here, examples of the removable recording medium 111 include a flexible disk, a compact disc read only memory (CD-ROM), a magneto optical (MO) disk, a digital versatile disc (DVD), a magnetic disk, a semiconductor memory, and the like.

Note that the program can be installed in the computer from the removable recording medium 111 as described above, or can be downloaded to the computer via a communication network or a broadcast network and installed in the hard disk 105 included in the computer. That is, for example, the program can be wirelessly transferred from a download site to the computer via an artificial satellite for digital satellite broadcasting, or can be transferred by wire to the computer via a network such as a local area network (LAN) or the Internet.

The computer includes a central processing unit (CPU) 102, and an input/output interface 110 is connected to the CPU 102 via a bus 101.

When a command is input by a user operating an input unit 107 or the like via the input/output interface 110, the CPU 102 executes a program stored in the read only memory (ROM) 103 in accordance with the command. Alternatively, the CPU 102 loads the program stored in the hard disk 105 into a random access memory (RAM) 104 and executes the program.

Therefore, the CPU 102 performs the processing in accordance with the above-described flowchart or the processing performed by the configuration of the above-described block diagram. Then, the CPU 102 outputs the processing result from the output unit 106 or transmits the processing result from the communication unit 108, for example, via the input/output interface 110, records the processing result in the hard disk 105, or performs other processing as necessary.

Note that the input unit 107 includes a keyboard, a mouse, a microphone, and the like. Furthermore, the output unit 106 includes a liquid crystal display (LCD), a speaker, and the like.

Here, in the present specification, the processing performed by the computer in accordance with the program is not necessarily performed in time series in the order described as the flowchart. That is, the processing performed by the computer in accordance with the program also includes processing performed in parallel or individually (for example, parallel processing or processing using objects).

Furthermore, the program may be processed by one computer (processor) or may be processed in a distributed manner by a plurality of computers. Moreover, the program may be transferred to a remote computer and executed.

Moreover, in the present specification, a system means a set of a plurality of components (devices, modules (parts), and the like), and it does not matter whether or not all the components are in the same housing. Therefore, a plurality of devices housed in separate housings and connected via a network and one device having a housing in which a plurality of modules is housed are both systems.

Furthermore, for example, a configuration described as one device (or processing unit) may be divided into and configured as a plurality of devices (or processing units). Conversely, configurations described above as a plurality of devices (or processing units) may be collectively configured as one device (or processing unit). Furthermore, a configuration other than the above-described configurations may be added to the configuration of each device (or each processing unit). Moreover, as long as the configuration and operation of the entire system are substantially the same, a part of the configuration of a certain device (or processing unit) may be included in the configuration of another device (or another processing unit).

Furthermore, for example, the present technology can have a configuration of cloud computing in which one function is shared and processed in cooperation by a plurality of devices via a network.

Furthermore, for example, the above-described program can be executed in any device. In that case, it is only required that the device have a necessary function (functional block or the like) and can acquire necessary information.

Furthermore, for example, steps described in the above-described flowcharts can be performed by one device or can be shared and executed by a plurality of devices. Moreover, in a case where a plurality of pieces of processing is included in one step, the plurality of pieces of processing included in the one step can be executed by one device or can be shared and executed by a plurality of devices. In other words, a plurality of pieces of processing included in one step can also be performed as pieces of processing of a plurality of steps. Conversely, the pieces of processing described as a plurality of steps can be collectively executed as one step.

Note that, the program executed by a computer may be created such that, pieces of processing of steps describing the program are performed in time series in the order described in the present specification, or may be executed in parallel or individually at necessary timing such as when a call is made. That is, as long as there is no contradiction, the pieces of processing of the steps may be executed in an order different from the above-described order. Moreover, the processing of steps describing the program may be performed in parallel with processing of another program, or may be performed in combination with processing of another program.

Note that each of a plurality of the present technologies described in the present specification can be implemented independently as a single technology as long as there is no contradiction. Of course, out of the present technologies, any multiple technologies can be implemented in combination. For example, some or all of the present technologies described in any of the embodiments can be implemented in combination with some or all of the present technologies described in other embodiments. Furthermore, a part or whole of any of the above-described present technologies can be implemented in combination with a technology that is not described above.

### Combination Example of Configurations

Note that the present technology may have the following configurations.

(1)

An information processing device comprising:

a topic selection unit that selects a topic appropriate to a context of an ongoing dialog on a basis of user information updated in accordance with a dialog state of a user; and

a determination unit that determines whether or not it is a timing to utter the topic in accordance with a time since a last occurrence of turn-taking in a dialog performed between a plurality of the users.

(2)

The information processing device according to above-described (1) further comprising a dialog state measurement unit that measures a dialog state of the user by using at least one of biological information of the user, an image obtained by imaging a surrounding situation including the user, voice uttered by the user, or position information indicating a position of the user, and acquires the user information.

(3)

The information processing device according to above-described (2), wherein

the dialog state measurement unit includes:

an internal state detection unit that detects an internal state of the user on a basis of the biological information;

a recognition information detection unit that detects recognition information indicating a state of an environment recognized by the user on a basis of the image;

a presented information detection unit that detects presented information presented by the user on a basis of the voice; and

an external environment detection unit that detects an external environment of the user on a basis of the position information, and

the dialog state measurement unit acquires at least one of the internal state, the recognition information, the presented information, or the external environment as the user information updated in accordance with a dialog state of the user.

(4)

The information processing device according to above-described (2) or (3) further comprising a chat mode switching unit that determines whether or not a context expects generation of a chat based on the topic selected by the topic selection unit by using at least one of the biological information, the image, or the voice, wherein

in a case where it is determined that the context expects generation of a chat, the chat mode switching unit notifies the dialog state measurement unit of the determination to cause the dialog state measurement unit to supply the user information to the topic selection unit.

(5)

The information processing device according to above-described (4), wherein

the chat mode switching unit includes:

a concentration degree measurement unit that measures a concentration degree of the user on a basis of the biological information;

an object specification unit that specifies an object in which the user is interested on a basis of the image; and

an utterance situation recognition unit that recognizes an utterance situation of the user on a basis of the voice, and

the chat mode switching unit determines whether or not the user is in a state of allowing a chat on a basis of at least one of the degree of concentration, the object, or the utterance situation.

(6)

The information processing device according to above-described (4) or (5) further comprising an operation command topic selection unit that selects the topic based on registered user information registered in advance regarding the user in accordance with an input of the operation command by the user, wherein

in a case where it is determined that the context does not expect the chat to be generated, the chat mode switching unit notifies the operation command topic selection unit of the determination to cause the operation command topic selection unit to select the topic in accordance with the registered user information.

(7)

The information processing device according to any one of (1) to (6), wherein

the topic selection unit includes:

a first selection processing unit that selects at least one topic based on registered user information registered in advance regarding the user; and

a second selection processing unit that selects, from among topics selected by the first selection processing unit, a topic based on the user information updated in accordance with a dialog state of the user.

(8)

The information processing device according to above-described (7), wherein the topic selection unit acquires, from the user, an utterance that prompts a dialog as the user information updated in accordance with a dialog state of the user, and selects the topic on a basis of the user information.

(9)

The information processing device according to above-described (7), wherein the topic selection unit acquires, from a user, a question as the user information, and selects a response to the question as the topic.

(10)

The information processing device according to any one of (1) to (9), wherein the determination unit determines that it is a timing to utter the topic when a voiceless section, in which utterance is not performed when a conversation is being performed between a plurality of users, exceeds a predetermined time set in advance.

(11)

An information processing method performed by a processing device, the method comprising:

selecting a topic appropriate to a context of an ongoing dialog on a basis of user information updated in accordance with a dialog state of a user; and

determining whether or not it is a timing to utter the topic in accordance with a time since a last occurrence of turn-taking in a dialog performed between a plurality of the users.

(12)

A program for causing a computer of an information processing device to perform information processing comprising:

selecting a topic appropriate to a context of an ongoing dialog on a basis of user information updated in accordance with a dialog state of a user; and

determining whether or not it is a timing to utter the topic in accordance with a time since a last occurrence of turn-taking in a dialog performed between a plurality of the users.

Note that the present embodiment is not limited to the above-described embodiment, and various modifications can be made without departing from the gist of the present disclosure. Furthermore, the effects described in the present specification are merely examples and are not limited, and other effects may be provided.

### REFERENCE SIGNS LIST

11 Dialog system
12 Information processing device
13 Biological sensor
14 Imaging device
15 Sound collecting device
16 Position sensor
17 Output device
21 Sensing result acquisition unit
22 Chat mode switching unit
23 Dialog state measurement unit
24 and 25 Topic selection unit
26 Voiceless section determination unit
27 Utterance generation unit
31 Concentration degree measurement unit
32 Object specification unit
33 Utterance situation recognition unit
41 Internal state detection unit
42 Recognition information detection unit
43 Presented information detection unit
44 External environment detection unit
51 First topic database
52 First selection processing unit 52
53 Second topic database
54 Second selection processing unit

1. An information processing device comprising:
a topic selection unit that selects a topic appropriate to a context of an ongoing dialog on a basis of user information updated in accordance with a dialog state of a user; and
a determination unit that determines whether or not it is a timing to utter the topic in accordance with a time since a last occurrence of turn-taking in a dialog performed between a plurality of the users.

2. The information processing device according to claim 1 further comprising a dialog state measurement unit that measures a dialog state of the user by using at least one of biological information of the user, an image obtained by imaging a surrounding situation including the user, voice uttered by the user, or position information indicating a position of the user, and acquires the user information.

3. The information processing device according to claim 2, wherein
the dialog state measurement unit includes:
an internal state detection unit that detects an internal state of the user on a basis of the biological information;
a recognition information detection unit that detects recognition information indicating a state of an environment recognized by the user on a basis of the image;
a presented information detection unit that detects presented information presented by the user on a basis of the voice; and
an external environment detection unit that detects an external environment of the user on a basis of the position information, and
the dialog state measurement unit acquires at least one of the internal state, the recognition information, the presented information, or the external environment as the user information updated in accordance with a dialog state of the user.

4. The information processing device according to claim 2 further comprising a chat mode switching unit that determines whether or not a context expects generation of a chat based on the topic selected by the topic selection unit by using at least one of the biological information, the image, or the voice, wherein
in a case where it is determined that the context expects generation of a chat, the chat mode switching unit notifies the dialog state measurement unit of the determination to cause the dialog state measurement unit to supply the user information to the topic selection unit.

5. The information processing device according to claim 4, wherein
the chat mode switching unit includes:
a concentration degree measurement unit that measures a concentration degree of the user on a basis of the biological information;
an object specification unit that specifies an object in which the user is interested on a basis of the image; and
an utterance situation recognition unit that recognizes an utterance situation of the user on a basis of the voice, and
the chat mode switching unit determines whether or not the user is in a state of allowing a chat on a basis of at least one of the degree of concentration, the object, or the utterance situation.

6. The information processing device according to claim 4 further comprising an operation command topic selection unit that selects the topic based on registered user information registered in advance regarding the user in accordance with an input of the operation command by the user, wherein
in a case where it is determined that the context does not expect the chat to be generated, the chat mode switching unit notifies the operation command topic selection unit of the determination to cause the operation command topic selection unit to select the topic in accordance with the registered user information.

7. The information processing device according to claim 1, wherein
the topic selection unit includes:
a first selection processing unit that selects at least one of the topic based on registered user information registered in advance regarding the user; and
a second selection processing unit that selects, from among the topics selected by the first selection processing unit, the topic based on the user information updated in accordance with a dialog state of the user.

8. The information processing device according to claim 7, wherein the topic selection unit acquires, from the user, an utterance that prompts a dialog as the user information updated in accordance with a dialog state of the user, and selects the topic on a basis of the user information.

9. The information processing device according to claim 7, wherein the topic selection unit acquires, from a user, a question as the user information, and selects a response to the question as the topic.

10. The information processing device according to claim 1, wherein the determination unit determines that it is a timing to utter the topic when a voiceless section, in which utterance is not performed when a conversation is being performed between a plurality of users, exceeds a predetermined time set in advance.

11. An information processing method performed by a processing device, the method comprising:
selecting a topic appropriate to a context of an ongoing dialog on a basis of user information updated in accordance with a dialog state of a user; and
determining whether or not it is a timing to utter the topic in accordance with a time since a last occurrence of turn-taking in a dialog performed between a plurality of the users.

12. A program for causing a computer of an information processing device to perform information processing comprising:
selecting a topic appropriate to a context of an ongoing dialog on a basis of user information updated in accordance with a dialog state of a user; and
determining whether or not it is a timing to utter the topic in accordance with a time since a last occurrence of turn-taking in a dialog performed between a plurality of the users.
